(19) United States
(12) Patent Application Publication
(10) Pub. No.: US 2004/0250223 A1
(43) Pub. Date: Dec. 9, 2004

(54) Optimal circuit verification method

(76) Inventor: Jose Luis L. Quiroga, Bogota (CO)

Correspondence Address: Jose L Quiroga, Calle 119A 53A 15, Bogota, CO

(21) Appl. No.: 10/477,436

(22) PCT Filed: Jun. 15, 2001
(86) PCT No.: PCT/IB01/01480

(51) Int. Cl. G06F 9/45; G06F 17/50

(52) U.S. Cl. 716/5; 716/3

(57) ABSTRACT

There exits a general optimal method to do circuit verification of one-output digital combinational switching circuit gate designs. The method is optimal in its use of resources of space and time. It uses a transformation of the data structures representing the circuit to the canonical representation of the problem. It then applies a sequence of steps that warrantees the optimal use of resources.

The main technical field related to this method is circuit designing. Several techniques used in different areas of electronic engineering, computer science, genetics, physics and mathematics are easily transformable to this presentation of the problem. Such transformations are said to be easy because they do not require more resources than this method itself. Binary Decision Diagrams (BDD), Automated Test Pattern Generation (ATPG), Combinational Equivalence Checking (CEC), Super scalar processor verification, FPGA routing, Noise Analysis, Optimal Storage and Retrieval, Compilation of Computer Languages, etc. are some of those areas and techniques.

There exits a general optimal method to do circuit verification of one-output digital combinational switching circuit gate designs. The method is optimal in its use of resources of space and time. It uses a transformation of the data structures representing the circuit to the canonical representation of the problem. It then applies a sequence of steps that warrantees the optimal use of resources.

The main technical field related to this method is circuit designing. Several techniques used in different areas of electronic engineering, computer science, genetics, physics and mathematics are easily transformable to this presentation of the problem. Such transformations are said to be easy because they do not require more resources than this method itself. Binary Decision Diagrams (BDD), Automated Test Pattern Generation (ATPG), Combinational Equivalence Checking (CEC) [Joa00], Super scalar processor verification, FPGA routing, Noise Analysis, Optimal Storage and Retrieval [Cor90], Compilation of Computer Languages, etc. are some of those areas and techniques.

Introduction.

There is a long story of no satisfaction around this problem. As it is well known in the literature the combinational verification problem of one-output switching circuits is one of the NP-Complete class problems [Jawa97]. The presentation of all of these problems can be transformed to any other presentation using polynomial resources of space and time [Cor90]. The canonical formal presentation of this problem [Cor90, Joa99] is the SAT problem more generally the k-SAT problem. It has been long time believed that it was not possible to solve the SAT problem using polynomial resources.

The philosophy of the general solution is that the problem falls under its own weight. Do to the fact that if you check every possibility, the amount of resources grows exponentially and the only apparent complete solution is to actually check every possibility, let us count instead of checking. Let us write “10” instead of “IIIIIIIIII”. Otherwise it would be like checking.

Solution.

For this particular problem the algorithm contained in the method is the method itself because the data structures that are processed with the algorithm represent physical, practical, technical data: a circuit. So, the words “algorithm” and “method” will be used without discrimination.

For any instance of circuit satisfiability the data structure representing the circuit can be transformed, using polynomial resources, to the canonical form of the SAT problem. So, the first step of the algorithm is to transform the data representing the gate design of the single output combinational switching circuit to the k-SAT problem [Joa95 p33, Cor90, Joa99, Joa00]. And then, an implementation of the following algorithm, which will be called PSAT( ) from now on, can be applied.

For the rest of this description the terminology and definitions in [Joa95] will be used.

PSAT( ) can be put together by selecting some specific techniques of the several ones mentioned in [Joa95]. It says in [Joa95] chapter 3 page 73: “In general, subsumption operations are computationally expensive”, referring to the possible techniques to maintain the clause database. At the end of [Joa95], the complexity analysis of the approach without the subsume operations concludes that it has an exponential complexity of time [Joa95, p263]. However, as PSAT( ) shows, subsume operations are not too expensive.

For polynomial use of resources, basically two techniques are needed. One of them is CDB (conflict-directed backtracking). That is, non-chronological backtracking with BCP (Boolean Constraint Propagation), and basic conflict analysis with MC (Multiple Conflict Analysis) and UIPs (Unique Implication Points). The second one is subsumed clause recording of conflicting implicates in the database (pages 57, 68, 69, 73, 86, 88, 93 of [Joa95]).

A presentation of the algorithm PSAT( ) is specified with the following procedures:

GRASP( ) [Joa95, p62]

Search( )[Joa95, p62]

Deduce_MC( ) [Joa95, p77]

Diagnose_MC( ) [Joa95 p97]

With the following observations:

In GRASP( ), Preprocess( ) simplifies each clause so that each literal in the clause is of a different variable; does a subsume operation for each pair of clauses in the initial database; and returns “SUCCESS”.

In GRASP( ), Postprocess( ) does nothing.

In Search( ) use Deduce_MC( ) and Diagnose_MC( ) instead of Deduce( ) and Diagnose( ).

In Diagnose_MC( ) call a procedure subsume( )right after the call to “Update_Clause_Database”.

The subsume( )procedure checks subsumption of each added clause against each clause of the database and deletes from the database every subsumed clause. Similar to the call to Subsume_Merge_Clauses( ) in [Joa95, p90] with REDUCE_DATABASE set to true, but not allowing to merge, just subsume.

For the purposes of the method itself and of polynomial use of resources (optimal use of resources) it doesn't matter how the subsume( )procedure is implemented because the complexity still the same. For purposes of its software implementation it is very important because the performance can be severely affected.

The recommended software implementation of the subsume operation is with prime numbers representing literals and a multiplication of them representing clauses so that a single comparison of subsumption takes a hardware implemented real division between the integers representing the two clauses. This would make a subsume operation's complexity look like a constant (a single hardware operation) instead of a square on the number of bits of the represented information which is the complexity hidden by the hardware division.

The data structures used in [Joa01] are used together with the one mentioned here for all other purposes of the software implementation.

All other performance considerations regarding a software implementation of the algorithm, especially those regarding to BCP and conflict analysis, are found in [Joa01].

The best performance of the algorithm will be achieved with a parallel hardware implementation. Maybe using photo-refractive materials instead of electronic or optoelectronic implementations. It will take some time until the industry and the technology to produce that kind of hardware are mature enough.

Soundness and completeness of the algorithm without the subsume( ) procedure are proved in [Joa95, p255]. The proofs with the subsume( ) procedure are very similar. The main impact of subsume( ) is in the complexity of the algorithm.

Some techniques mentioned in the literature can improve performance for some instances of the problem, like: caching solutions [Joa95, p117] [JoaJ98] and formula partitioning [JoaJ98]. Some others make a polynomial change in complexity, like: iterated conflicts [Joa95, p91] and recursive learning [JoaS98]. And some others are incompatible with polynomial use of resources, like: constant size databases [Joa95, p98], k-consistency [Joa95, p79], relaxation [Joa95, p81] and relevance-based learning [JoaJ98]. The partial improvements and polynomial changes in complexity are explained with the observation of redundancy of those techniques with PSAT( ). The incompatibility is explained by observing the restrictions imposed by those techniques on the database. The database has to be kept as a prime implicate database (of some unknown function) with the subsume operations.

The following uses the terminology, definitions and theorems in [Joa95]. Theorems 2.3 and A.4 in [Joa95, p47, p265] are of special relevance. Pages 46, 47, 48 (FIG. 2.10), 44 (FIG. 2.7) and 52 of [Joa95] are also of special relevance.

Theorem B.

The total number of backtracks of PSAT( ) using subsume( ) as specified above is proportional to the size of the initial database.

Proof Argument.

After any backtrack of the algorithm and for each clause CL in the database: The number of backtracks due to CL done until now are in inverse proportion to the number of clauses in the database when CL was added. This is thanks to subsumption of each added clause (it keeps the database as a prime implicate database), completeness of BCP with respect to a prime implicate database, and completeness of basic conflict analysis with UIPs and MC with respect to the Ic generated with BCP. Each present prime implicate clause CL assures that the number of backtracks that will have to be done, until CL is removed or the algorithm finishes, is strictly less than the number of backtracks that would have to be done if CL were not in the database. This “strictly” could not be “assured” without subsumption been applied for each added “prime implicate” clause and so the “inverse proportion” would not hold.

Using the following:

B is the total number of backtracks done by PSAT( ).

Bi is the number of backtracks until now due to clause “i”.

N is the initial size of the database.

Ni is the number of clauses the database when clause “i” was added.

ka, kb, kc are constants.

Sum(inf, sup, term) is the sum of the terms “term” with “i” changing from “inf” to “sup”.

Power(base, exponent) is “base to the exponent”.

Log(number) is “logarithm of number”.

O(function) is “Order of function”.

Juxtaposition means multiplication.

“/” is the division in R.

“˜” is proportionality.

The paragraph above means:

Bi ˜1/Ni

O(Bi)=O(1/Ni)

So, for the total number of backtracks B in the worst case (not satisfiable or satisfied just before the last backtrack) and after the algorithm finishes:

O(B)=O(Sum(0, Power(ka, N), 1/Ni))

O(B)=O(kb Log(Power(ka, N)))=O(kc N)=O(N)

The polynomial functions representing the time and space complexities of PSAT( ) are explained with a similar analysis to the one of theorem A.4 in [Joa95] together with the above theorem.

### REFERENCES

[Cor90] Thomas Cormen, Charles Leiserson, Ronald Rivest, “Introduction to Algorithms”, 1990.

[Joa95] João P. Marques-Silva, “Search Algorithms for Satisfiability Problems in Combinational Switching Circuits”, Ph.D. Dissertation, EECS Department, University of Michigan, May 1995. Paper downloadable from “http://sat.inesc.pt/˜jpms/”.

[JoaJ98] João P. Marques-Silva, “An Overview of Backtrack Search Satisfiability” Algorithms, in Fifth International Symposium on Artificial Intelligence and Mathematics, January 1998.

[JoaS98] João P. Marques-Silva, “Improving Satisfiability Algorithms by Using Recursive Learning”, in Proceedings of the International Workshop on Boolean Problems (IWBP), September 1998.

[Joa99] João P. Marques-Silva and Thomas Glass, “Combinational Equivalence Checking Using Satisfiability and Recursive Learning”, in Proceedings of the IEEE/ACM Design, Automation and Test in Europe Conference (DATE), March 1999.

[Jawa97] Jawahar Jain, Rajarshi Mukherjee, Koichiro Takayama; U.S. Pat. No. 6,086,626. Filed: May 16, 1997. Assigned: Jul. 11, 2000.

[Joa00] João P. Marques-Silva and Karem A. Sakallah. “Boolean Satisfiability Algorithms and Applications in Electronic Design”. Tutorial, presented at the Conference on Computer-Aided Verification (CAV), July 2000.

[Joa01] Software GRASP downloadable from “http://sat.inesc.pt/˜jpms/”

1. A circuit gate design processing method by computer and a computer-readable storage medium containing a computer algorithm;
where said algorithm is to do the general optimal, i.e. sound and complete with polynomial complexity, solution of the circuit verification problem for a one-output combinational switching circuit gate design;
said circuit gate design represented by a data structure; and
said algorithm further comprising the steps of:
transforming the data structure representing said circuit gate design to its canonical form, known as the k-SAT presentation of said circuit verification problem, by means of existing techniques known to do said transforming with optimal use of resources of space and time; and
executing on said canonical form a sound and complete combination of known techniques that verifies said canonical form with optimal use of resources of space and time by means of the proportional relation between the initial size of the database and the number of backtracks, that is generated when subsume operations are used as the most distinctive mechanism that conditions the use of space, since only prime implicates are kept in the database;
said combination of known techniques comprising the techniques of:
conflict-directed backtracking based on the result of a previously executed unique implication points analysis as the core of a diagnose engine with multiple conflict analysis that is executed if a previously executed deduction engine, that executes a Boolean constraint propagation technique, finds at least one conflict; and
subsuming of clause recording for the conflicting implicates found by said core, where said subsuming is executed right after said recording during the execution of said diagnose engine, and where said subsuming is the most distinctive condition for the use of space, since the recorded clauses are kept as a prime implicate database of conflicting implicates, that leads to the optimal use of both space and time during execution of said combination of known techniques.

2. The method according to claim 1, wherein said combination of known techniques further comprises any technique selected from the group consisting of: cashing solutions, formula partitioning, iterated conflicts, or recursive learning.
